(19) United States
(12) Patent Application Publication
(10) Pub. No.: US 2006/0268156 A1
(43) Pub. Date: Nov. 30, 2006

(54) Stabilizer platform for a camcorder

(76) Inventor: Charles Gale, San Dimas, CA (US)

Correspondence Address: Andrew Y. Schroeder, Esq.;Suite 222, 500 S. Broadway, Santa Maria, CA, 93454, US

(21) Appl. No.: 11/142,752

(22) Filed: May 31, 2005

(51) Int. Cl. H04N 5/225

(52) U.S. Cl. 348/373

(57) ABSTRACT

A camera stabilizer comprising a platform having a first end connectable to a camera and a second end extending outwardly from the first end to rest on a shoulder of a camera operator; said first end connected to said second end with a locking bolt, said locking bolt sized to fit through both a first end hole and a second end hole, said locking bolt sized to fit with a locking knob, said locking knob being threaded to accept said locking bolt, said locking bolt to be inserted through an upper surface of said first end through said first end and through said second end hole, and said locking bolt to connect with said locking knob, said first end having a camera hole sized to fit with a camera screw threaded pin, said camera screw threaded pin sized to engageably attach to a camera for use in affixing said camera to said platform, said camera screw threaded pin to be inserted through an under surface of said first end held in place by a retaining ring to affix with camera.

### FIELD OF THE INVENTION

The present invention is in the area of electronics and more particularly pertains to visual recording accessories.

### BACKGROUND OF THE INVENTION

This invention relates to a stabilizing platform support for a camcorder or other visual recording devices. Said invention rests on the shoulder of a camera operator to video subject thereby eliminating up and down motion normally incurred while filming.

It is common knowledge that camcorders on the market today due to their small size have an inherent problem of producing a poor quality picture due to hand movement of the user which is not stable thus producing a shaky, unsteady and jittery picture. Even with the stabilizing chip that is present in the camcorder body today does not remedy the jittery movements since a user will video for long periods of time and tire while doing so or walk or run while videoing thus magnifying the problem.

Prior attempts have been made to eliminate the unwanted up and down motions typical in amateur videoing or photography through a stabilization mechanism which is either supported by the user's shoulder or by a body harness.

U.S. Pat. No. 2,370,611 to Du Mais is a bulky and complicated apparatus with interlocking members which hold a still camera and requires a strap around the arm. This is not practical or helpful for use with the camcorders of today.

U.S. Pat. No. 4,542,966 to Knaudt is a shoulder and hand support for photographic equipment which is supported by an arm connection for rapid picture sequence for a still camera. This support uncomfortably hangs over the shoulder like an arch and comes down to the rib cage and includes many locking mechanisms.

U.S. Pat. No. 4,984,090 to Sasaki et al is a grip that can be mounted underneath a camera. Once mounted and electronically connected there is a power switch of a trigger type that will video only when the trigger is depressed. This is not suitable for long-term video taping. The user must hold this camera with one or both hands and there is no stabilizing attachment reaching to the shoulder which can provide stabilization and comfort and ease in the use of the camera especially for long-term video taping.

U.S. Pat. No. 5,038,160 to Schumacher et al is a camera support apparatus which slides into a compact position. The bar is wider at the front and narrows at the back where it rests on the shoulder. This presents a heavier load in the front causing imbalance and discomfort and is not practical in use. The use of slider plates introduces a potential for pinching or injury to the user.

U.S. Pat. No. 5,073,788 to Lingwall is a cumbersome camera apparatus which requires the use of hinges, straps, fasteners and a body harness to attach to the user for still photography.

U.S. Pat. No. 5,081,478 to Hayashida et al is a tool which attaches to the camera for holding or for carrying purposes which tucks under the camera for compact storage or use as a tripod. In certain instances this device cannot be stored compactly or thinly in the camera bottom portion. U.S. Pat. No. 5,098,182 to Brown is a complicated and cumbersome support system used to stabilize camera equipment for unwanted motions. There are two “struts” which extend from the base support making the device difficult to hold or balance, especially due to the counterbalancing by a secondary view finding device and batteries at the bottom of the first strut.

U.S. Pat. No. 5,128,701 to Hampton is a device having a platform to hold a small video camcorder which provides stabilization for photography by extending the platform to the shoulder. There are finger grips on each side with which to hold the device causing the user's fingers to be cramped in a bent position to support and steady the camera. While gripping the stabilizer, a user's hand is not free to control the basic functions of a camera such as zooming, power, and other attendant functions. To make the apparatus more compact in a stowed position, the apparatus is folded by pulling down the shoulder support member into the housing which is located in the camera support member.

U.S. Pat. No. 5,742,859 to Acker is a support device for stabilizing a camera, particularly a video camera. It has many attachments, struts, pivoting joints with upper yoke, straps for use which make it cumbersome and complicated, especially when the extension pole is introduced for lifting and tilting the camera over and above the user's shoulders or as use of a monopod.

U.S. Pat. No. 5,749,011 to Nicolaci is a stabilizing rod to attach to the bottom of a video camera to steady the picture image. This device would be uncomfortable for use especially for long periods of video taping as well as having inherent personal protection flaws for designing and suggesting this device can be placed against the face and neck.

UK Patent 2,103,379 is a device designed for use of two cameras which are of the still type for simultaneous use. The advantage would be that the user could use two types of film, eg. Black and white for one with color for the other, or slow film for one and fast for the other. The other advantage of this device is that twice the number of exposures can be made per second in an action sequence thus describing the still, 35 mm type camera and is not practical for video cameras.

Japan Patent JP403132632 is a device which attaches itself to a video camera serving as a handle with an electronically connected remote control at the bottom of the handle which can also be attached to a tripod. This device will do nothing for stabilization of the picture as one would not have differing results by holding the camera with his hand. The hand is still doing the holding for the only support with the resulting jitter and unwanted movements of the hand.

Consequently a need exists for a camcorder stabilizing platform and camcorder design which addresses the problems of previous designs.

### SUMMARY OF THE INVENTION

To address the problems of prior stabilizing mechanisms, the present invention includes a stabilizing platform which attaches to the bottom of a small hand held digital or DVD camcorder with still camera capabilities to steady the filming of subjects. The platform includes a two piece bar that is held together with a locking bolt and includes a mounting screw which attaches the camera to the top of the platform.

It is an objective of this invention to provide a steady and stable support for a camcorder, hand held camcorder, digital hand held camcorder with still camera features or DVD digital hand held camcorder with still camera features. The support facilitates steady recording and then viewing from either the viewfinder or the liquid crystal display screen of the subject thus eliminating the up and down or jittery motion commonly encountered during video recording.

It is a further objective of this invention to provide a lightweight support, easily manufactured with minimal cost to be produced on a mass production basis.

### BRIEF DESCRIPTION OF THE DRAWING FIGURES

FIG. 1 is a perspective view of an exemplary preferred embodiment of the present invention.

FIG. 2 is a side view of an exemplary preferred embodiment of the present invention

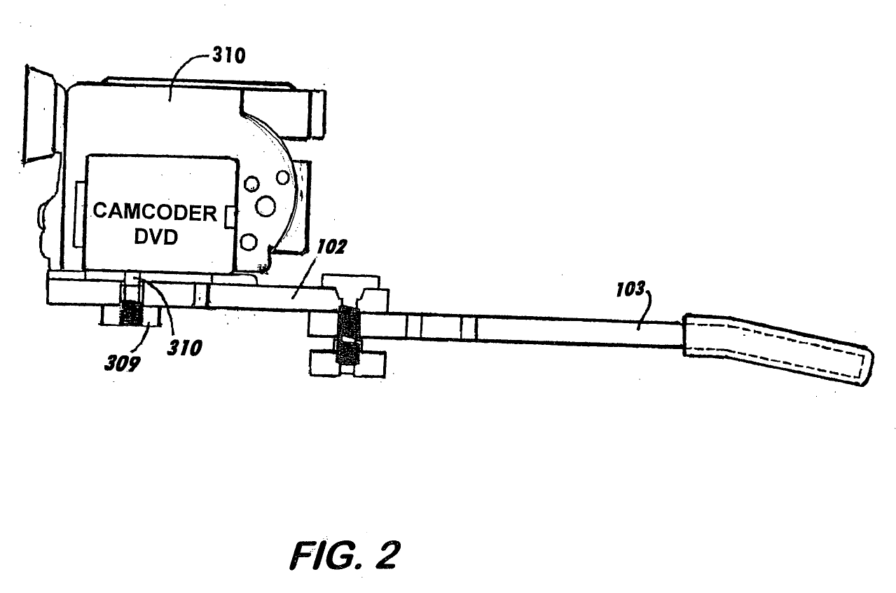

FIG. 3 is a perspective view of an exemplary preferred embodiment of the present invention.

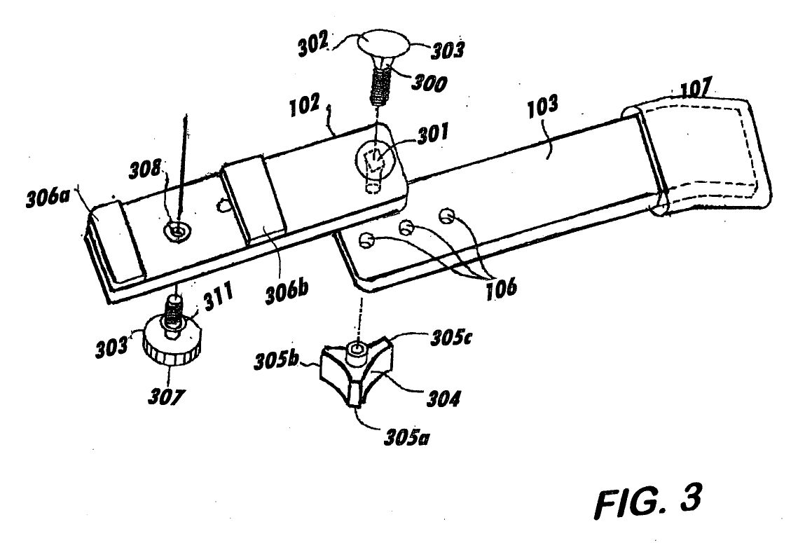

FIG. 4 is a side view of an exemplary preferred embodiment of the present invention.

### DESCRIPTION OF PREFERRED EMBODIMENTS

According to a preferred embodiment of the present invention, an apparatus is used for the stabilization of video recording equipment. The apparatus along with attendant methods are explained in enabling detail below.

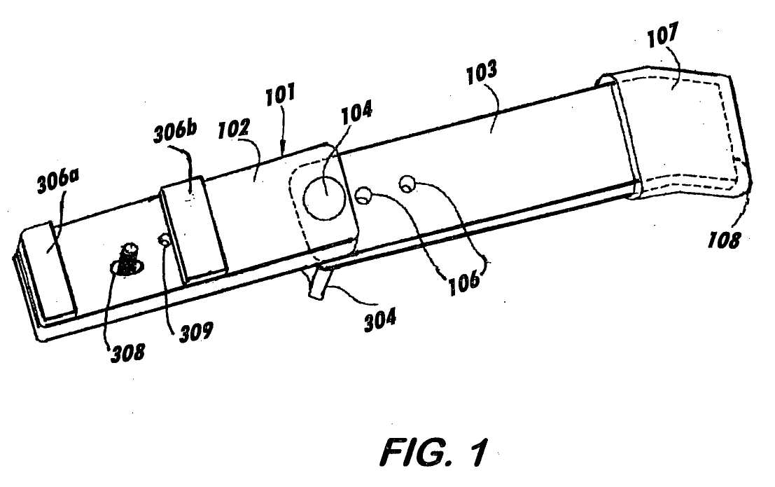

FIG. 1 is a perspective view of a preferred embodiment of the present invention. Stabilizer platform comprises a bar 101. Bar 101 comprises a first section 102 and a second section 103. First section 102 and second section 103 are rotatably connected together by a locking bolt 104, which passes through holes 301 and 106 extending through first section 102 and second section 103, respectively. Hole 106 can be one of a number of holes positioned in second section 103 so that the overall length of bar 101 in the extended position can vary, depending upon the specific user utilizing the invention. Located near camera pad 306b is a bore hole for future use 309. A foam pad 107 is positioned on an end 108 of second section 103 opposite from holes 106. Preferably end 108 is bent slightly downwardly and includes pad 107 to rest comfortably on the shoulder of the camera user.

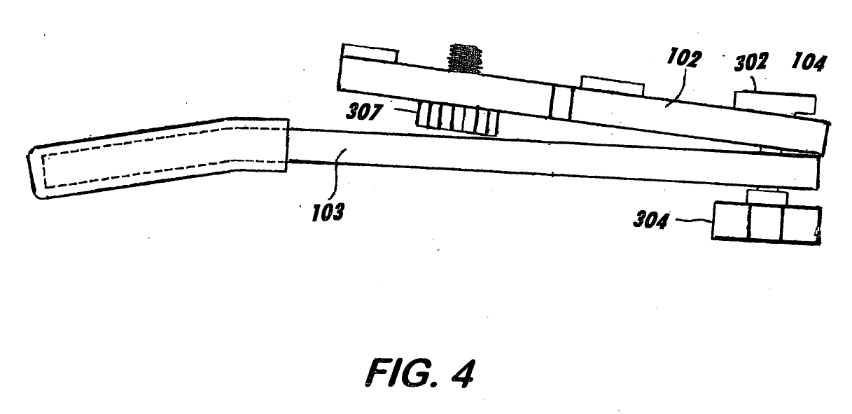

Preferably hole 301 has a square geometry extending at least part way through the thickness of first section 102 to accommodate the square section 300 on locking bolt 302 beneath head 303. Locking bolt 302 as previously indicated passes through holes 301 and 106 and into locking knob 304, which threads onto locking bolt 302 and rigidly locks first and second section 102, 103 in its fully extended position. Locking knob 304 is shown as having three flanges 305a, 305b and 305c, which facilitate tightening the locking knob 304 onto locking bolt 302 by rotation with the fingers of the user. Although shown with three flanges, locking knob 304 can be other types of knobs commercially available, such circular knobs or any other type of fastening means. As will be discussed in more detail herein, locking bolt 302 and locking knob 304 also secure first section 102 and second section 103 of the stabilizer bar 101 in a stowed position as shown in FIG. 4.

Positioned on the upper surface of the first section 102 of the stabilizer bar 101 are camera pads 306a and 306b, which preferably are made of foam rubber and include a pressure-sensitive adhesive to keep the camera pads in position on the upper surface of the first section. Camera pads 306a and 306b provide a cushion and friction attachment point for the video camera on the upper surface of the first section 102 which also has a bore hole for future use.

The camera screw threaded pin 307 is inserted through hole 308 in the first section 102 and is held in place by a retaining ring 311 to hold the camera screw firmly in place on the first section 102. The threaded pin 307 then extends up above the upper surface of the first section 102 and is threaded into a threaded tripod hole positioned on the bottom of the camcorder 310.

As seen best in FIG. 4 the stabilizer platform of the present invention can be easily folded and stowed in a compact position. The locking knob 304 and locking bolt 302 can be loosened so that the first section 102 and second section 103 can be rotated to a collapsed position. The length of the invention is then half the size and can be conveniently stored in a video camera bag while still attached to the camera. The first section 102 and second section 103 of the invention may be constructed from any type of material ranging from lightweight aluminum, plastics, or carbon fiber depending upon economic factors, use factors or manufacturing limitations.

The stabilizing platform of the present invention allows the user to form a three-point support system wherein the platform rests on the user's shoulder, one hand holds the camera hand strap, while the upper arm is resting by the user's body. Although the present invention has been described with respect to two embodiments thereof, it is to be understood that changes and modifications can be made therein which are within the intended scope of the invention as hereinafter claimed.

What is claimed is:

1. A camera stabilizer comprising:
a platform having a first end connectable to a camera and a second end extending outwardly from the first end to rest on a shoulder of a camera operator; said first end connected to said second end with a locking bolt, said locking bolt sized to fit through both a first end hole and a second end hole, said locking bolt sized to fit with a locking knob, said locking knob being threaded to accept said locking bolt, said locking bolt to be inserted through an upper surface of said first end through said first end and through said second end hole, and said locking bolt to connect with said locking knob, said first end having a camera hole sized to fit with a camera screw threaded pin, said camera screw threaded pin sized to engageably attach to a camera for use in affixing said camera to said platform, said camera screw threaded pin to be inserted through an under surface of said first end held in place by a retaining ring to affix with camera.

2. The camera stabilizing platform of claim 1 further comprising at least two camera pads affixed to said first end, said camera pads affixed to opposite sides of said camera screw threaded pin.

3. The camera stabilizer of claim 2 wherein said camera pads are made of foam rubber.

4. The camera stabilizer of claim 1 wherein said second end has a plurality of holes sized to fit with said locking bolt.

5. The camera stabilizer of claim 4 wherein said second end has a plurality of holes sized to fit with said locking bolt.

6. The camera stabilizer of claim 1 wherein said second end further comprises a foam pad on a distal end opposite said second end hole.

7. The camera stabilizer of claim 5 wherein said second end further comprises a foam pad on a distal end opposite said second end hole.

8. The camera stabilizer of claim 5 wherein said distal end with said foam pad is bent at an angle for placement on a shoulder of a camera operator.

9. The camera stabilizer of claim 1 wherein said distal end with said foam pad is bent at an angle for placement on a shoulder of a camera operator.

10. The camera stabilizer of claim 1 wherein said locking knob possesses at least two flanges for use in affixing said locking knob with said locking bolt.

11. The camera stabilizer of claim 5 wherein said locking knob possesses at least two flanges for use in affixing said locking knob with said locking bolt.

12. The camera stabilizer of claim 1 further including a retaining ring to be used with said camera screw.

13. The camera stabilizer of claim 5 further including a retaining ring to be used with said camera screw.

14. The camera stabilizer of claim 1 wherein both said first end hole and said locking bolt have a square geometry extending at least part way through the thickness of said first section.

15. The camera stabilizer of claim 1 wherein said first end and said second end is made of aluminum.

16. The camera stabilizer of claim 5 wherein said first end and said second end is made of aluminum.

17. The camera stabilizer of claim 1 wherein said first end and said second end is made of plastic.

18. The camera stabilizer of claim 5 wherein said first end and second end is made of plastic.

19. The camera stabilizer of claim 1 wherein said first end and said second end is made of carbon fiber.

20. The camera stabilizer of claim 5 wherein said first end and said second end is made of carbon fiber.
